(19) United States
(12) Patent Application Publication
(10) Pub. No.: US 2017/0142172 A1
(43) Pub. Date: May 18, 2017

(54) Video Player for Multiple Cameras, Playing System and Playing Method

(71) Applicants: Le Holdings (Beijing) Co., Ltd., Beijing (CN); LeCloud Computing Co., Ltd., Beijing (CN)

(72) Inventors: Yuefeng Hu, Beijing (CN); Yafeng Xu, Beijing (CN); Di Hou, Beijing (CN)

(21) Appl. No.: 15/252,801

(22) Filed: Aug. 31, 2016

Related U.S. Application Data
(63) Continuation of application No. PCT/CN2016/083204, filed on May 24, 2016.

(30) Foreign Application Priority Data
Nov. 13, 2015 (CN) 201510781231.5

(51) Int. Cl. H04L 29/06; G11B 27/34

(52) U.S. Cl. CPC H04L 65/4069; G11B 27/34; H04L 65/602; H04L 65/607

(57) ABSTRACT

A video player for multiple cameras, a playing system and a playing method. The video player includes: an interface configuration module which is configured to provide a plurality of small play windows and a large play window; a video playing component which is configured to call a plurality of low code rate videos to be played in the plurality of small play windows respectively; and an audio and video playing component and a corresponding trigger module. When multiple videos are played at the same time, the audio and video played by the large play window is primary and the videos played by the small windows are secondary. Volume control is removed by separately compressing the videos played in the small play windows for secondary viewing. In addition, a user may flexibly and conveniently view different parts of the same video from multiple angles and multiple dimensions.

### CROSS REFERENCE TO RELATED APPLICATIONS

This application is a continuation of International Application No. PCT/CN2016/083204, filed on 24 May 2016, which is based upon and claims priority to Chinese Patent Application No. 201510781231.5, filed on 13 Nov. 2015, the entire contents of which are incorporated herein by reference.

### TECHNICAL FIELD

The disclosure relates to video playing, and more particularly to a video player for multiple cameras, a playing system and a playing method.

### BACKGROUND

With the development of network communication technologies and multimedia technologies, people use devices such as smart televisions, smart phones and tablet computers to play video files more frequently. In existing video playing systems, multiple cameras placed in different positions and angles capture images of a playing field (namely multi-camera shooting), but usually only one path of video is presented to a user and such video is the image captured by one certain camera selected by a director, and people viewing the video may not freely select the images captured by other cameras. People try to use multi-screen (or multi-window) playing, but the data needed to process are greatly increased. In existing playing conditions (for example, common video cards and players), the multi-screen playing has the problems that the definition of the video played in multi-screens is low and blocking and time delay appear in the multi-screen playing process. These problems limit the multi-screen playing capacity and reduce the desire of people using multiple screens to play the video.

Therefore, how to avoid the problem that the blocking and time delay appear in the multi-screen playing process while ensuring the definition becomes one of concerns in the industry.

### SUMMARY

The disclosure provides a video player for multiple cameras, a playing system and a playing method for solving the technical problems in the prior art that the definition of video played in multi-screens is low and blocking and time delay appear in the multi-screen playing process.

An embodiment of the disclosure provides a video player for multiple cameras. The video player includes at least one processor, and a memory communicably connected with the at least one processor for storing instructions executable by the at least one processor, wherein execution of the instructions by the at least one processor causes the at least one processor to:

provide a plurality of small play windows and a large play window;

call a plurality of low code rate videos to be played in the plurality of small play windows respectively; and

call high code rate audio and video play in said large play window in response to a designating operation on any one of the plurality of small play window, wherein said high code rate audio and video corresponds to the low code rate video played in the small window as designated by said trigger module.

Another embodiment of the disclosure provides a video playing system for multiple cameras, the system including the above video player, the multiple cameras and a configuration server, wherein:

the multiple cameras are configured to capture images and generate corresponding stream media files; and

the configuration server is configured to communicate with the multiple cameras respectively, receive the stream media files and generate a high code rate audio and video and a low code rate audio and video.

Still another embodiment of the disclosure provides a video playing method for multiple cameras, the method including:

capturing images and generating corresponding stream media files by the multiple cameras;

receiving the stream media files and generating a high code rate audio and video and a low code rate audio and video by a configuration server;

providing a video player for the multiple cameras, wherein an interface configuration module of the video player is provided with a plurality of small play windows and a large play window;

establishing communication between the video player and the configuration server; and

configuring addresses of low code rate audio and video files to be played in the plurality of small play windows, playing the low code rate audio and video files, and playing in the large play window, when a designating operation is performed on one of plurality of small play windows, a high code rate audio and video file corresponding to a low code rate audio and video file in said one of plurality of small play windows being designated.

In one embodiment, configuring addresses of low code rate audio and video files to be played in the plurality of small play windows, playing the low code rate audio and video files, and playing in the large play window, when a designating operation is performed to one of plurality of small play windows, playing, a high code rate audio and video file corresponding to a low code rate audio and video file in said one of plurality of small play windows being designated includes:

setting a low code rate video address in each of a plurality of small play windows;

downloading and playing the low code rate video based on said low code rate video address;

generating an instruction set containing a plurality of playing instructions for said audio and video playing component according to the setting of the low code rate video address by said video address configuration unit, wherein each playing instruction includes downloading and playing an audio and video with a high code rate audio and video address corresponding to the low code rate video address;

selecting one of the plurality of small play windows; and

establishing correlation between the designating operation on a small play window by said window selection unit and one of the plurality of playing instructions, such that the high code rate audio and video played in the large play window by said audio and video playing component corresponds to the low code rate video played in the small play window selected by the window selection unit.

In one embodiment, configuring addresses of low code rate audio and video files to be played in the plurality of small play windows, playing the low code rate audio and video files, and playing in the large play window, when a designating operation is performed to one of plurality of small play windows, a high code rate audio and video file corresponding to a low code rate audio and video file in said one of plurality of small play windows being designated includes:

setting a low code rate video address in each of a plurality of small play windows;

downloading and playing the low code rate video based on said low code rate video address;

selecting one of the plurality of small play windows;

obtaining a low code rate video address set in one of said small play windows according to a designating operation on one of the small play windows by said window selection unit, and searching for a corresponding high code rate audio and video address based on said low code rate video address; and

sending an inquired high code rate audio and video address to said audio and video playing component, and downloading and playing the high code rate audio and video in the large play window.

Firstly, in one embodiment, the high code rate audio and video may be played in the large play window and the low code rate videos may be played in respective small play windows that are on the same play interface as the large play window. By the designating operation on any small play window, the high code rate video and audio played in the large play window may be switched to the high code rate video and audio corresponding to the small play window, so that a user can view different parts of the same video from multiple angles and dimensions.

Secondly, in one embodiment, when multiple videos are played at the same time, the audio and video played by the large play window is primary and the videos played by the small windows are secondary. As long as the high quality of a video source (for example the high code rate audio and video) of the large play window is ensured without the need of ensuring the high quality of the video resources of the small play windows, a clear enough main picture played by the large play window may be ensured, and the user experience is enhanced.

Thirdly, in one embodiment, volume control is removed by compressing the code rates of the videos played in respective small play windows, thereby avoiding the problems of excessive high voices caused by overlapping of multiple video voices and interference of the multiple voices, thus improving the video playing quality.

Fourthly, volume control is removed by compressing the code rates of the videos played in respective small play windows, thereby reducing an occupation rate of a CPU and a memory, greatly reducing a data operand, relieving the burden of a player, so that the user can view smooth videos in multiple windows even in a case that the hardware (for example the display card) is not updated, and the problems that blocking and time delay appear in the multi-screen video live playing process can be solved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural drawing of function modules of a video player for multiple cameras according to an embodiment of the disclosure;

FIG. 2(a) is a schematic structural drawing of an embodiment of a trigger module in FIG. 1;

FIG. 2(b) is a schematic structural drawing of another embodiment of a trigger module in FIG. 1;

FIG. 3 is a schematic structural drawing of an embodiment of a playing component in FIG. 1;

FIG. 4(a) is a schematic drawing of a video playing interface according to an embodiment of the disclosure;

FIG. 4(b) is a schematic drawing of a video playing interface according to another embodiment of the disclosure;

FIG. 5 is a schematic structural drawing of a video playing system for multiple cameras according to an embodiment of the disclosure;

FIG. 6(a) is a schematic structural drawing of an embodiment of a configuring server in FIG. 5;

FIG. 6(b) is a schematic structural drawing of another embodiment of a configuring server in FIG. 5;

FIG. 7 is a schematic flow chart of a video playing method for multiple cameras according to an embodiment of the disclosure;

FIG. 8(a) is a schematic drawing of an embodiment of a sub-flow in FIG. 7;

FIG. 8(b) is a schematic drawing of another embodiment of a sub-flow in FIG. 7; and

FIG. 9 is a schematic structural drawing of a computer system of a terminal device or server for realizing the embodiments of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but not all embodiments. Based on the embodiments of the disclosure, other embodiments obtained by the ordinary skill in the art without inventive efforts are within the scope of the disclosure.

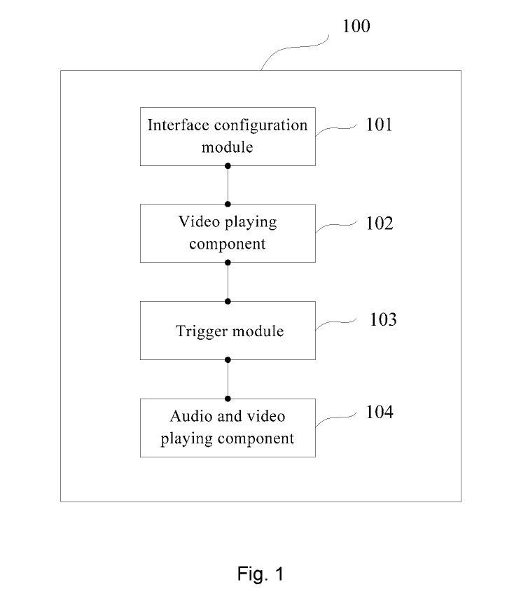

FIG. 1 is a schematic structural drawing of function modules of a video player for multiple cameras according to an embodiment of the disclosure. As shown in FIG. 1, the video player 100 for multiple cameras includes an interface configuration module 101, a video playing component 102, a trigger module 103 and an audio and video playing component 104.

The interface configuration module 101 is configured to provide a plurality of small play windows and a large play window.

The video playing component 102 is configured to call a plurality of low code rate videos to be played in the plurality of small play windows respectively.

The trigger module 103 is configured to activate the audio and video playing component based on a designating operation on any one of the plurality of small play windows.

The audio and video playing component 104 is configured to call high code rate audio and video play in the large play window in response to the designating operation of the trigger module, wherein the high code rate audio and video corresponds to the low code rate video played in the small window with the designating operation of the trigger module.

In this embodiment, the video playing component 102 may be a player only supporting video decoding and rendering without supporting audio decoding. Therefore, configuration requirements of hardware may be reduced, a data operand is reduced and the burden of a player is relieved.

In this embodiment, the quantity of the video playing component 102 may be one or corresponds to that of the small play windows (for example, the quantities of the video playing component 102 and the small play windows are both five), thereby ensuring that the low code rate video played by each small play window has a corresponding video playing component 102.

In this embodiment, the audio and video playing component 104 may be a player supporting video decoding and rendering and audio decoding, thereby ensuring the high quality playing of the high code rate audio and video file in the large play window.

In this embodiment, the code rate is the total data traffic of a video picture every second, and is simply understood as “definition”. The high code rate audio and video may be, for example, a standard-definition audio and video (for examples, parameters are 512*336 15 fps h.264 0.3 Mbps), a high-definition audio and video (for examples, parameters are 640*432 25 fps h.264 0.5 Mbps) and an ultra-definition audio and video (for examples, parameters are 960*720 25 fps h.264 1 Mbps), while the low code rate video is a video with the definition lower than that of the standard-definition video.

A switching manner of the video player in video playing is explained in an example in which a user uses the video player of this embodiment.

Five groups (10 videos) of video files are provided, including for example, a high code rate audio and video 1 and a low code rate video 1; a high code rate audio and video 2 and a low code rate video 2; a high code rate audio and video 3 and a low code rate video 3; a high code rate audio and video 4 and a low code rate video 4; and a high code rate audio and video 5 and a low code rate video 5. At the beginning, the video player plays begins playing in a direction from left to right, i.e., the low code rate video 1 in the first small play window, the low code rate video 2 in the second small play window . . . to the low code rate video 5 in the fifth small play window. The high code rate audio and video 1 is defaulted to be played in the large play window. When the second small play window is performed with the designating operation (for example, a mouse clicking operation), the large play window plays the high code rate audio and video 2. When the third small play window is performed with the designating operation (for example, a mouse click operation), the large play window plays the high code rate audio and video 3. Similarly, the small play window 4 or 5 may be performed with the same designating operation.

Firstly, in one embodiment, the high code rate audio and video may be played in the large play window and the low code rate videos may be played in respective small play windows that are on the same play interface as the large play window. By the designating operation on any small play window, the high code rate video and audio played in the large play window may be switched to the high code rate video and audio corresponding to the small play window, so that a user can view different parts of a video from multiple angles and dimensions.

Secondly, in one embodiment, when multiple videos are played at the same time, the audio and video played by the large play window is primary and the videos played by the small windows are secondary. As long as the high quality of a video source (for example the high code rate video) of the large play window is ensured without the need of ensuring the high quality of the video resources of the small play windows, a clear enough main picture played by the large play window can be ensured, and the user experience is enhanced.

Thirdly, in one embodiment, volume control is removed by compressing the code rates of the videos played in respective small play windows, thereby avoiding the problems of excessive high voices caused by overlapping of multiple video voices and interference of the multiple voices, thus improving the video playing quality.

Fourthly, volume control is removed by compressing the code rates of the videos played in respective small play windows, thereby reducing an occupation rate of CPU and memory, greatly reducing data operand, relieving the burden of a player, so that the user can view smooth videos in multiple windows even in a case that the hardware (for example the display card) is not updated, and the problems that blocking and time delay appear in the multi-screen video live playing process can be solved.

In this embodiment, the video player 100 may further include an inter-cut component related with the audio and video playing component 104. When the inter-cut component is in an activated state, the audio and video playing component suspends playing the high code rate audio and video, and the inter-cut component loads a pre-stored video in the large play window and splices a timestamp at a link between the played high code rate audio and video and the pre-stored video.

Therefore, in this embodiment, by inter-cutting the pre-stored video (for example an advertisement) into the video that is being played in each window, the two videos are merged to form a complete video, the inter-cut video is prevented from being deleted or modified randomly; further, others are prevented from infringing to use the video, and a preparation is made for the advertisement sales later.

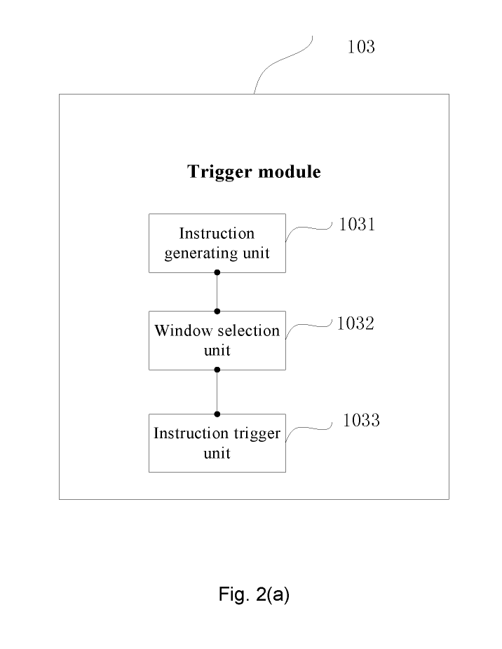

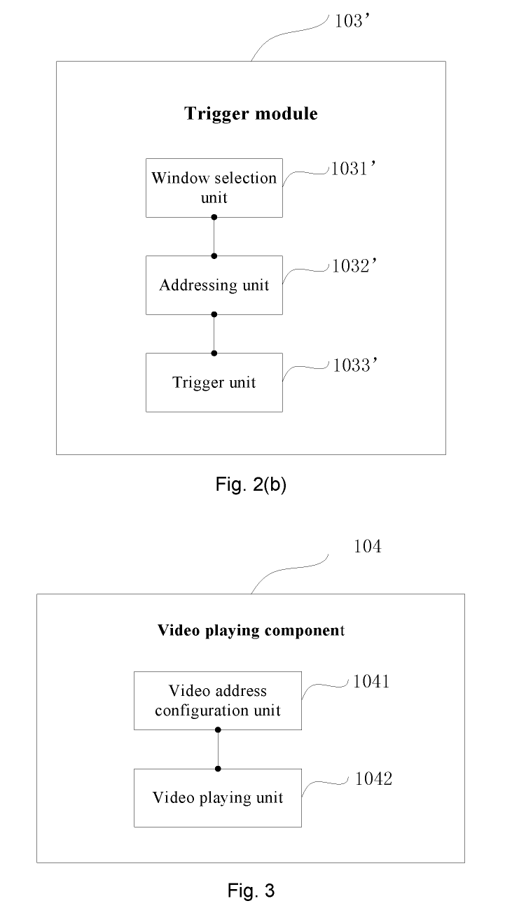

FIGS. 2(a) and 2(b) are schematic structural drawings of an embodiment and another embodiment of a trigger module in FIG. 1.

As shown in FIG. 2(a), the trigger module 3 may include an instruction generation unit 1031, a window selection unit 1032 and an instruction trigger unit 1033.

The instruction generation unit 1031 is configured to generate an instruction set containing a plurality of playing instructions for the audio and video playing component according to the setting of the low code rate video address by the video address configuration unit, wherein each playing instruction includes downloading and playing an audio and video with a high code rate audio and video address corresponding to the low code rate video address. For example, calling the high code rate audio and video 1 corresponding to an address add1 of the low code rate video 1, or calling the high code rate audio and video 2 corresponding to an address add 2 of the low code rate video 2, etc.

The window selection unit 1032 is configured to select one (for example the small play window 2) of the plurality of small play windows (for example, the small play window 1, the small play window 2 . . . the small play window 5).

The instruction trigger unit 1033 is configured to establish correlation between the designating operation on a small play window by the window selection unit and one of the plurality of playing instructions, such that the high code rate audio and video played in the large play window by the audio and video playing component corresponds to the low code rate video played in the small play window selected by the window selection unit.

Therefore, in this embodiment, by pre-configuring the address of the videos, the correlation is established between the designating operation and the playing instructions, and the designating operation may directly trigger to play the high code rate audio and video in the large play window (for example, a user clicks the small play window 2 with the mouse to play the high code rate audio and video 2 in the large play window; the user clicks the small play window 3 with the mouse to play the high code rate audio and video 3 in the large play window . . . the user clicks the small play window 5 with the mouse to play the high code rate audio and video 5 in the large play window), thereby reducing a data operand, improving the video downloading and playing speed and avoiding the problems of blocking and time delay in playing videos.

As shown in FIG. 2(b), the trigger module 103′ may include a window selection unit 1031′, an addressing unit 1032′ and a trigger unit 1033′.

The window selection unit 1031′ is configured to select one of the plurality of small play windows.

The addressing unit 1032′ is configured to obtain a low code rate video address set in one of the small play windows according to a electing operation on one of the small play windows by the window selection unit, and retrieve a corresponding high code rate audio and video address based on the low code rate video address; and

The trigger unit 1033′ is configured to send the retrieved high code rate audio and video address to the audio and video playing component, and download and play the high code rate audio and video in the large play window.

In this embodiment, an address table may be stored in a server, to correspond the address of the high code rate audio and videos to that of the low code rate videos. Therefore, one of the small play windows is selected to map the address of the low code rate video in the small play window. Then, based on the correlation between the address of the high code rate audio and videos and that of the low code rate videos, the corresponding high code rate address is retrieved by the mapped address of the low code rate video in the small play window. The trigger unit 1033′ sends the retrieved high code rate address to the audio and video playing component, and the high code rate audio and video is downloaded and played in the large play window. Therefore, in this embodiment, the high code rate audio and video corresponding to the low code rate video may be found in an addressing manner, an extra register is not required to store operating instructions, logic operation of the instructions is reduced and the video calling accuracy is improved.

FIG. 3 is a schematic structural drawing of a playing component embodiment in FIG. 1. As shown in FIG. 3, the video playing component 104 may include a video address configuration unit 1041 and a video playing unit 1042.

The video address configuration unit 1041 is configured to set a low code rate video address in each of a plurality of small play windows (for example, the address add1 of the low code rate video 1, the address add2 of the low code rate video 2 . . . the address add5 of the low code rate video 5).

The video playing unit 1042 is configured to download and play the low code rate video based on the low code rate video address.

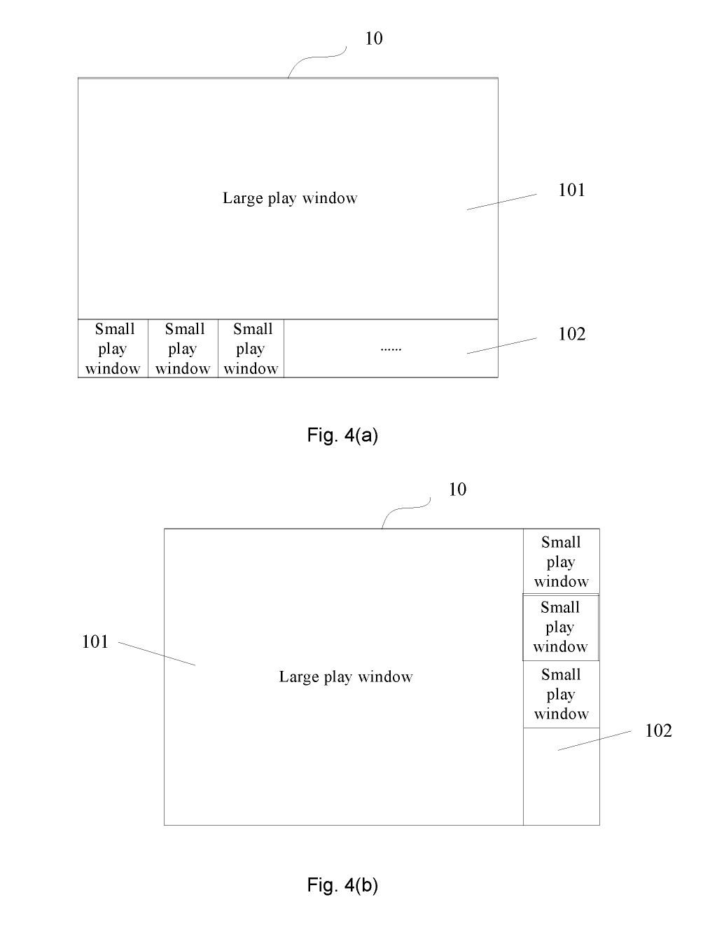

FIGS. 4(a) and 4(b) are schematic drawings of an embodiment and another embodiment of a video playing interface of the disclosure. The video playing interface 10 is an interface generated when the video player plays video or audio and video.

As shown in FIG. 4(a), the upper part of the video playing interface 10 is a large play window 101, and the lower part of the video playing interface 10 is small play windows 102. In a playing state of the video player, the high code audio and video is displayed in the large display window 101. The low code rate videos are displayed in the plurality of small play windows 102. At this point, a high code rate video picture can be seen and an audio voice may be heard from the large play window 101. Only respective low code rate video pictures may be seen from the small play windows 2 without hearing the audio voice.

Therefore, in this embodiment, voice is removed by compressing the videos so as to reduce the occupation rate of a CPU and a memory, and reduce a data operand. The problems of video blocking or excessive high voice caused by voice overlapping and the interference among multiple video voices can be avoided and the video playing quality is improved.

In this embodiment, an area of the large play window 101 is at least 6 times of that of the small play windows.

As it is known from massive experimental data, when the area of the large play window 101 is at least six times that of the small play window, the definition and smoothness of the video of the large pay window are optimal in a case that the viewing of the videos of the small play windows is not negatively affected and video switching is convenient.

FIG. 4(a) and FIG. 4(b) are different only in window configurations, but similar in design principle, and the similar parts of the two are not repeated. As shown in FIG. 4(b), the left part of the video playing interface 10 is a large play window 101, and the right part of the video playing interface 10 is a plurality of small play windows 102.

In this embodiment, the playing interface may be performed with other personalized designs as required. For example, the small play windows and large play window are arranged in a personalized manner, thereby meeting the personalized experience of the user.

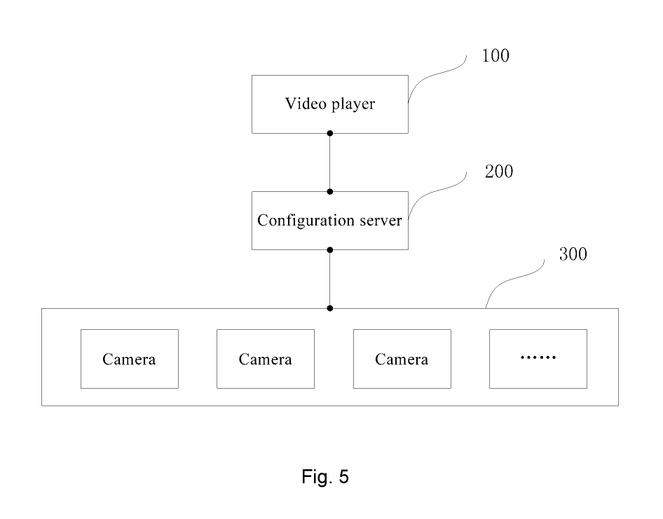

FIG. 5 is a schematic structural drawing of a video playing system for multiple cameras according to an embodiment of the disclosure. As shown in FIG. 5, the video playing system for multiple cameras may include multiple cameras 300, a configuration server 200 and a video player 100.

The multiple cameras 300 are configured to capture images and generate corresponding stream media files.

In this embodiment, the multiple cameras 300 may be a plurality of cameras placed in different positions and angles to capture images of a playing field.

The configuration server 200 is configured to communicate with the multiple cameras respectively, receive the stream media files and generate a high code rate audio and video and a low code rate audio and video.

The video player 100 is in communication with the configuration server to obtain high code rate audio and video addresses and low code rate video addresses.

In this embodiment, an address table may be stored in a server to correspond the address of the high code rate audio and videos to the low code rate videos. By interaction information between the configuration server 200 and the video player 100, the addresses of the videos may be configured, and the correlation between the addresses may be performed with addressing, thereby playing the high code rate audio and videos and the low code rate videos as required.

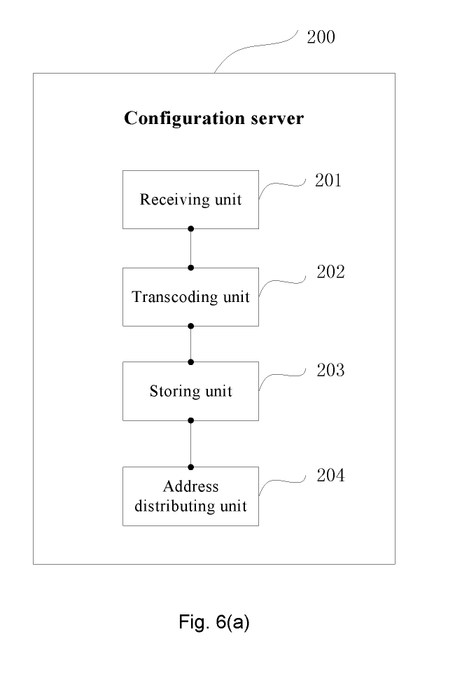

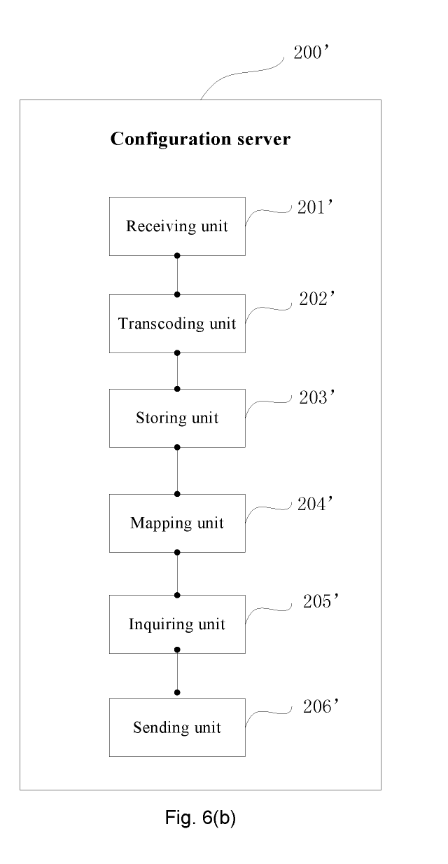

FIGS. 6(a) and 6(b) are schematic structural drawings of an embodiment and another embodiment of a configuring server in FIG. 5.

As shown in FIG. 6(a), the configuration server 200 may include a receiving unit 201, a transcoding unit 202, a storing unit 203 and an address distributing unit 204.

The receiving unit 201 is configured to receive the stream media files from the multiple cameras.

The transcoding unit 202 is configured to transcode the stream media files to generate audios and videos of high code rate and of low code rate respectively.

The storing unit 203 is configured to store the generated high code rate audio and video and low code rate audio and video, and generate addresses for the high code rate audio and video and the low code rate audio and video respectively.

The address distributing unit 204 is configured to, in response to calling of the low code rate video by the video playing component, distribute an address of the high code rate audio and video associated with the called low code rate video to the video playing component.

As shown in FIG. 6(b), the configuration unit 200′ may include a receiving unit 201′, a transcoding unit 202′, a storing unit 203′, a mapping unit 204′, a querying unit 205′ and a sending unit 206′.

The receiving unit 201′ is configured to receive the stream media files from the multiple cameras.

The transcoding unit 202′ is configured to transcode the stream media files to generate the high code rate audio and video and the low code rate audio and video.

The storing unit 203′ is configured to store the generated high code rate audio and video and low code rate audio and video, and generate addresses for the high code rate audio and video and the low code rate audio and video.

The mapping unit 204′ is configured to map an address set for the low code rate video in the small play window in response to the selection operation of the window selection unit to the small play window.

The querying unit 205′ is configured to query an address of the high code rate audio and video based on the mapped address of the low code rate video.

The sending unit 206′ is configured to send a queried address of the high code rate audio and video to the trigger module.

In one embodiment, the configuration server 200 may further include a video compressing unit. The video compressing unit performs lossless compressing processing on high code rate audio and video files, and performs voice removing compressing processing on low code rate video files.

Therefore, the embodiment may compress the received video files, the compressing may be lossless compressing, such that the storage space is greatly reduced while a picture quality is ensured, and a video transmission rate is improved.

In one embodiment of the disclosure, respective functions of the related function modules may be realized by a hard processor and respective units.

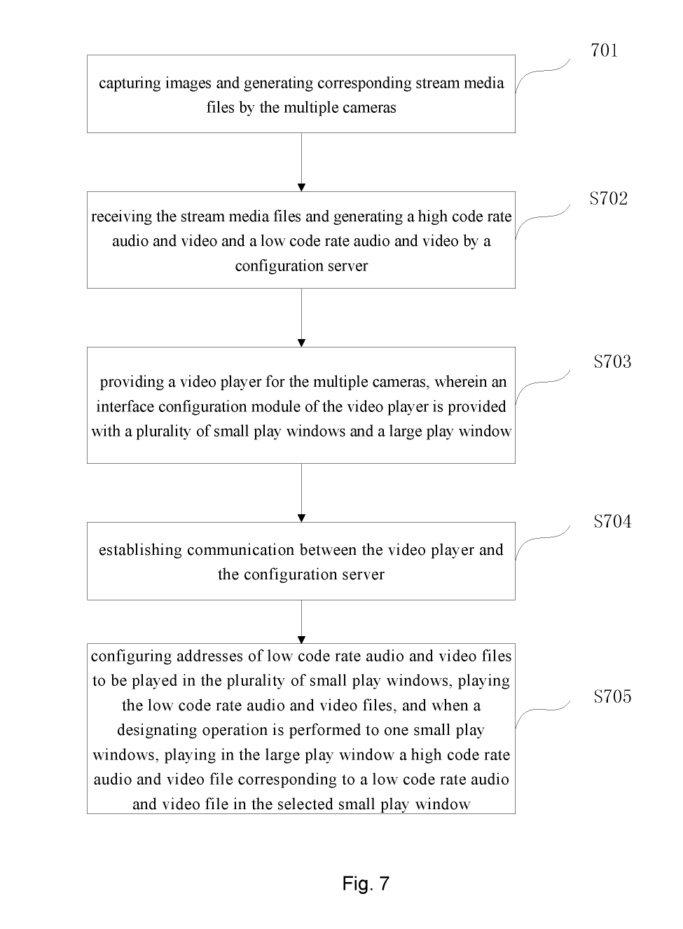

FIG. 7 is a schematic flow chart of an embodiment of a video playing method for multiple cameras. As shown in FIG. 7, the video playing method for multiple cameras may include the following steps.

S701: Images are captured and corresponding stream media files are generated by the multiple cameras.

S702: The stream media files are received and a high code rate audio and video and a low code rate audio and video are generated by a configuration server.

In this embodiment, 5 groups of high code rate audio and video files and low code rate video files (10 files) may be generated, the files including for example, a high code rate audio and video 1 and a low code rate video 1; a high code rate audio and video 2 and a low code rate video 2; a high code rate audio and video 3 and a low code rate video 3; a high code rate audio and video 4 and a low code rate video 4; and a high code rate audio and video 5 and a low code rate video 5.

S703: A video player for the multiple cameras is provided, wherein an interface configuration module of the video player is provided with a plurality of small play windows and a large play window.

In this embodiment, FIGS. 4(a) and 4(b) may be referred to for the configurations of the windows.

S704: Communication is established between the video player and the configuration server.

S705: Addresses of low code rate audio and video files to be played are configured in the plurality of small play windows to play the low code rate audio and video files. In the large play window, a high code rate audio and video file corresponding to a low code rate audio and video file in the selected small play window is played.

In this embodiment, addresses of low code rate audio and video files to be played are configured in the plurality of small play windows. The low code rate audio and video files are played. The high code rate audio and video file corresponding to the low code rate video file in the small play window in the first position is played in the large play window by default. When a designating operation is performed to one of plurality of small play windows, in the large play window, a high code rate audio and video file corresponding to a low code rate audio and video file in the one designated small play window is played.

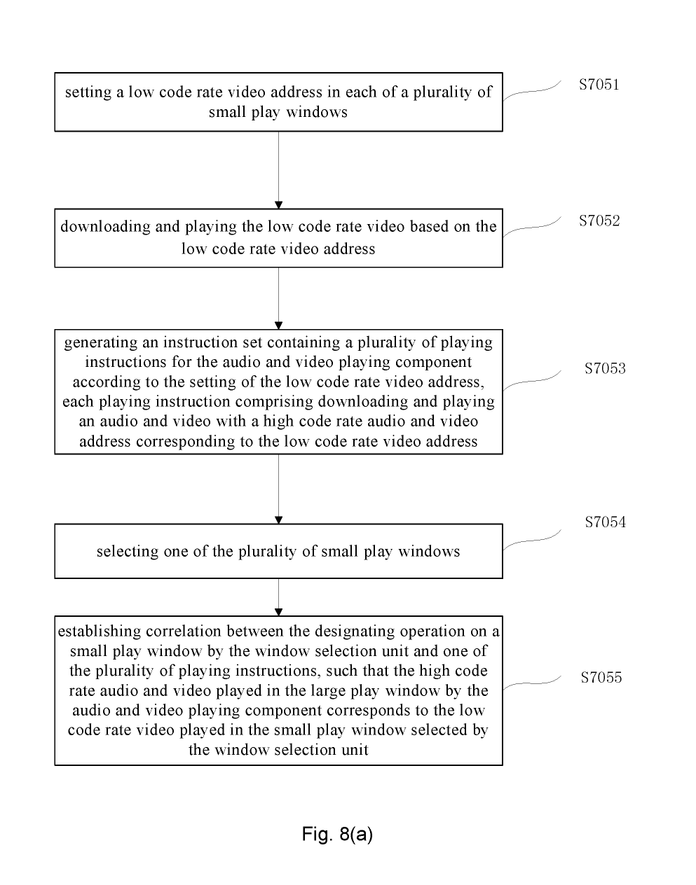

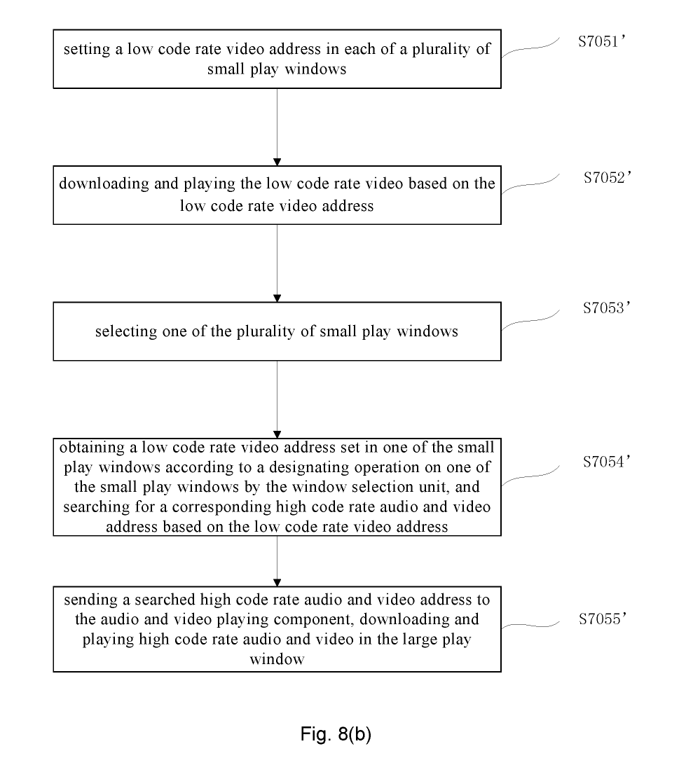

FIG. 8(a) is a schematic drawing of an embodiment of a sub-flow in FIG. 7. As shown in FIG. 8, the step S705 in FIG. 7 may include:

S7051: setting a low code rate video address in each of a plurality of small play windows (for example, the address add1 of the low code rate video 1, the address add2 of the low code rate video 2 . . . the address add5 of the low code rate video 5);

S7052: downloading and playing the low code rate video based on the low code rate video address;

S7053: generating an instruction set containing a plurality of playing instructions for the audio and video playing component according to the setting of the low code rate video address by the video address configuration unit, wherein each playing instruction includes downloading and playing an audio and video with a high code rate audio and video address corresponding to the low code rate video address;

S7054: selecting one of the plurality of small play windows; and

S7055: establishing correlation between the designating operation on a small play window by the window selection unit and one of the plurality of playing instructions, such that the high code rate audio and video played in the large play window by the audio and video playing component corresponds to the low code rate video played in the small play window selected by the window selection unit. Therefore, in this embodiment, the correlation is established between the designating operation and the playing instruction by pre-configuring the addresses of the videos, and the designating operation may directly trigger playing of the high code rate audio and video in the large play window.

For example, when a user clicks the small play window 2 with a mouse, the high code rate audio and video 2 is played in the large play window; when the user clicks the small play window 3 with the mouse, the high code rate audio and video 3 is played in the large play window . . . when the user clicks the small play window 5 with the mouse, the high code rate audio and video 5 is played in the large play window, thereby reducing a data operand, improving the video downloading and play speed and avoiding the problems of blocking and time delay of the videos.

FIG. 8(b) is a schematic view of a second embodiment of a sub-flow in FIG. 7. As shown in FIG. 8(b), the step S705 in FIG. 7 may include:

S7051′: setting a low code rate video address in each of a plurality of small play windows (for example, the address add1 of the low code rate video 1, the address add2 of the low code rate video 2 . . . the address add 5 of the low code rate video 5);

S7052′: downloading and playing the low code rate video based on the low code rate video address;

S7053′: selecting one of the plurality of small play windows;

S7054′: obtaining a low code rate video address set in one of the small play windows according to a designating operation on one of the small play windows by the window selection unit, and searching for a corresponding high code rate audio and video address based on the low code rate video address; and

S7055′: sending an searched high code rate audio and video address to the audio and video playing component, and downloading and playing the high code rate audio and video in the large play window.

In this embodiment, an address table may be stored in a server, to correspond the address of the high code rate audio and videos to that of the low code rate videos. Therefore, one of the small play windows is selected to map the address of the low code rate video in the small play window. Then, based on the correlation between the addresses of the high code rate audio and videos and the low code rate videos, the corresponding high code rate address is searched by the mapped address of the low code rate video in the small play window. The searched high code rate address is sent to the audio and video playing component, and the high code rate audio and video is downloaded and played in the large play window.

In this embodiment, the high code rate audio and video corresponding to the low code rate video may be found in an addressing manner, an extra register is not required to store operating instructions, logic operation of the instructions is reduced and the video calling accuracy is improved.

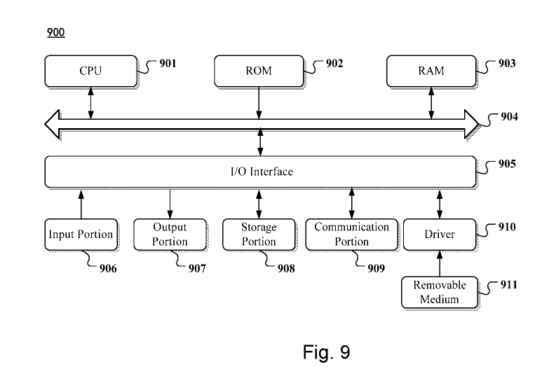

Further refer to FIG. 9 showing a schematic structural drawing of a computer system 900 of a terminal device or server for realizing the embodiments of the disclosure.

As shown in FIG. 9, the computer system 900 includes a central processing unit (CPU) 901 which may perform various appropriate actions and processing according to a program stored in a read-only memory (ROM) 902 or a program loaded to a random access memory (RAM) 903 from a storage part 908. Various programs and data required during operation of the system are also stored in the RAM 903. CPU 901, ROM 902 and RAM 903 are connected with one another via a bus 904. An Input/Output (I/O) interface 905 is also connected to the bus 904.

Components connected to the Input/Output (I/O) interface 905 includes an input part 906 including a keyboard, a mouse and the like, an output part 907 including a cathode ray tube (CRT), a liquid crystal display (LCD) and the like, the storage part 908 including a hard disk and the like, and a communication part 909 of network interface cards including an LAN card, a modem, etc. The communication part 909 performs communication processing via a network such as the Internet. A driver 910 is connected to the Input/Output (I/O) interface 905 as required. A removable medium 911 such as a magnetic disk, an optical disk, a magneto-optical disk or a semiconductor memory is installed on the driver 910 as required so as to enable a computer program to read out from the removable medium to be installed into the storage part 908 according to the needs.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are merely provided for describing the technical solutions of the disclosure, but not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A video player for multiple cameras, comprising at least one processor, and a memory communicably connected with the at least one processor for storing instructions executable by the at least one processor, wherein execution of the instructions by the at least one processor causes the at least one processor to:
provide a plurality of small play windows and a large play window;
call a plurality of low code rate videos to be played in the plurality of small play windows respectively; and
call high code rate audio and video play in said large play window in response to a designating operation on any one of the plurality of small play windows, wherein said high code rate audio and video corresponds to the low code rate video played in the small window as designated.

2. The video player according to claim 1, wherein execution of the instructions by the at least one processor further causes the at least one processor to:
set a low code rate video address in each of the plurality of small play windows;
download and play the low code rate video based on said low code rate video address.

3. The video player according to claim 2, wherein execution of the instructions by the at least one processor further causes the at least one processor to:
generate an instruction set comprising a plurality of playing instructions for said audio and video playing component according to the setting of the low code rate video address, wherein each playing instruction comprises downloading and playing an audio and video with a high code rate audio and video address corresponding to the low code rate video address;
select one of the plurality of small play windows; and
establish correlation between the designating operation on a small play window and one of the plurality of playing instructions, such that the high code rate audio and video played in the large play window corresponds to the low code rate video played in the selected small play window.

4. The video player according to claim 1, wherein execution of the instructions by the at least one processor further causes the at least one processor to:
set a low code rate video address in each of a plurality of small play windows;
download and play the low code rate video based on said low code rate video address;
select one of the plurality of small play windows;
obtain a low code rate video address set in one of said small play windows according to a designating operation on one of the small play windows, and search for a corresponding high code rate audio and video address based on said low code rate video address; and
send out a searched high code rate audio and video address, and download and play the high code rate audio and video in the large play window.

5. The video player according to claim 1, wherein execution of the instructions by the at least one processor further causes the at least one processor to suspend playing the high code rate audio and video when an inter-cut operation is activated, and load a pre-stored video in said large play window and splice a timestamp at a link between the played high code rate audio and video and the pre-stored video.

6. The video player according to claim 1, wherein an area of said large play window is at least 6 times of that of said small play window.

7. A video playing system for multiple cameras, comprising the video player of claim 1, the multiple cameras and a configuration server, wherein:
the multiple cameras capture images and generate corresponding stream media files; and
the configuration server communicates with the multiple cameras respectively, receive the stream media files and generate a high code rate audio and video and a low code rate audio and video.

8. The system of claim 7, wherein the configuration server comprises at least one processor, and a memory communicably connected with the at least one processor for storing instructions executable by the at least one processor, wherein execution of the instructions by the at least one processor causes the at least one processor to:
receive the stream media files from the multiple cameras;
transcode the stream media files to generate the high code rate audio and video and the low code rate audio and video;
store the generated high code rate audio and video and low code rate audio and video, and generate addresses for the high code rate audio and video and the low code rate audio and video; and
in response to calling of the low code rate video by the video playing component, distribute an address of the high code rate audio and video associated with the called low code rate video to the video playing component.

9. The system of claim 7, wherein execution of the instructions by the at least one processor causes the at least one processor to:
receive the stream media files from the multiple cameras;
transcode the stream media files to generate the high code rate audio and video and the low code rate audio and video; store the generated high code rate audio and video and low code rate audio and video, and generate addresses for the high code rate audio and video and the low code rate audio and video;
map an address set for the low code rate video in the small play window in response to the selection operation of the window selection unit to the small play window;
query an address of the high code rate audio and video based on the mapped address of the low code rate video; and
send a queried address of the high code rate audio and video to the trigger module.

10. A video playing method for multiple cameras, comprising:
capturing images and generating corresponding stream media files by the multiple cameras;
receiving the stream media files and generating a high code rate audio and video and a low code rate audio and video by a configuration server;
providing a video player for the multiple cameras, wherein an interface configuration module of the video player is provided with a plurality of small play windows and a large play window;
establishing communication between the video player and the configuration server; and
configuring addresses of low code rate audio and video files to be played in the plurality of small play windows, playing the low code rate audio and video files, and playing a high code rate audio and video file corresponding to a low code rate audio and video file in said one of plurality of small play windows as designated in the large play window when a designating operation is performed to one of plurality of small play windows.

11. A non-transitory computer-readable storage medium storing executable instructions that, when executed by an electronic device, cause the electronic device to:
provide a plurality of small play windows and a large play window;
call a plurality of low code rate videos to be played in the plurality of small play windows respectively; and
call high code rate audio and video play in said large play window in response to a designating operation on any one of the plurality of small play windows, wherein said high code rate audio and video corresponds to the low code rate video played in the small window as designated.

12. The non-transitory computer-readable storage medium of claim 11, when executed by an electronic device, cause the electronic device to:
set a low code rate video address in each of the plurality of small play windows;
download and play the low code rate video based on said low code rate video address.

13. The non-transitory computer-readable storage medium of claim 11, wherein execution of the instructions by the electronic device, cause the electronic device to:
generate an instruction set comprising a plurality of playing instructions according to the setting of the low code rate video address, wherein each playing instruction comprises downloading and playing an audio and video with a high code rate audio and video address corresponding to the low code rate video address;
select one of the plurality of small play windows; and
establish correlation between the designating operation on a small play window and one of the plurality of playing instructions, such that the high code rate audio and video played in the large play window corresponds to the low code rate video played in the selected small play window.

14. The non-transitory computer-readable storage medium of claim 11, wherein execution of the instructions by the electronic device, cause the electronic device to:
set a low code rate video address in each of a plurality of small play windows;
download and play the low code rate video based on said low code rate video address;
select one of the plurality of small play windows;
obtain a low code rate video address set in one of said small play windows according to a designating operation on one of the small play windows, and search for a corresponding high code rate audio and video address based on said low code rate video address; and
send out a searched high code rate audio and video address, and download and play the high code rate audio and video in the large play window.

15. The non-transitory computer-readable storage medium of claim 11, wherein execution of the instructions by the electronic device cause the electronic device to suspend playing the high code rate audio and video when an inter-cut operation is activated, and load a pre-stored video in said large play window and splice a timestamp at a link between the played high code rate audio and video and the pre-stored video.
